(19) United States
(12) Patent Application Publication
(10) Pub. No.: US 2020/0152438 A1
(43) Pub. Date: May 14, 2020

(54) MASS SPECTROMETER, LASER LIGHT INTENSITY ADJUSTING METHOD AND NON-TRANSITORY COMPUTER READABLE MEDIUM

(71) Applicant: Shimadzu Corporation, Kyoto-shi (JP)

(72) Inventor: Makoto HAZAMA, Kyoto-shi (JP)

(73) Assignee: Shimadzu Corporation, Kyoto-shi (JP)

(21) Appl. No.: 16/543,816

(22) Filed: Aug. 19, 2019

(30) Foreign Application Priority Data
Nov. 8, 2018 (JP) 2018-210820

(51) Int. Cl. H01J 49/16; H01J 49/42

(52) U.S. Cl. CPC H01J 49/164; H01J 49/0027; H01J 49/4295; H01J 49/424

(57) ABSTRACT

A mass spectrometer includes a MALDI ion source, an ion separator that separates ions generated from the MALDI ion source, a detector that detects ions ejected from the ion separator, a data processor that acquires a mass spectrum of the ion detected in the detector, and a controller that controls intensity of laser light with which the MALDI ion source is irradiated. The controller includes a determiner that determines whether a peak of a matrix is detected in the mass spectrum acquired in the data processor while increasing intensity of laser light emitted to a sample matrix mixture from a first intensity, and a setter that acquires intensity of laser light at a time point at which the peak of the matrix is detected as a second intensity, and sets the second intensity as intensity of laser light used for analysis of the sample.

### BACKGROUND OF THE INVENTION

### Field of the Invention

The present invention relates to a mass spectrometer, a laser light intensity adjusting method and a non-transitory computer readable medium storing a laser light intensity adjusting program that are used in the mass spectrometer.

### Description of Related Art

As an ion source used in a mass spectrometer, a MALDI ion source utilizing MALDI (Matrix Assisted Laser Desorption/Ionization) has been known. In the MALDI ion source, a sample is mixed with a matrix having a large amount. Then, a sample matrix mixture is irradiated with laser, which is an ultraviolet ray. The matrix absorbs laser light and converts the laser light into thermal energy. At this time, part of the matrix is rapidly heated and evaporated together with the sample.

Ions generated from the MALDI ion source pass through an ion separator such as an ion trap or TOF (Time Of Flight Mass Spectrometry) and are detected in a detector. The ions detected in the detector are analyzed in a data processing device, and a mass spectrum is acquired.

The MALDI ion source is characterized by being highly sensitive to laser light. Further, the MALDI ion source is characterized by being unlikely to cause fragmentation of a sample. Thus, the mass spectrometer using the MALDI ion source can analyze a sample having a large molecular weight, and is widely utilized in an analysis field of a polymer such as a biopolymer or a synthetic polymer. JP 4894916 B2 discloses a mass spectrometer utilizing the MALDI ion source and the ion trap.

### BRIEF SUMMARY OF THE INVENTION

While the MALDI ion source has the advantage of being highly sensitive to laser light, variations in amount of generated ions with respect to the intensity of laser light are large. Therefore, it is difficult to estimate the relationship between the intensity of laser light and an amount of generated ions. Further, even in the case where the same substance is utilized as a matrix, when a different sample is used, an amount of generated ions with respect to the intensity of laser light changes. Further, an amount of generated ions with respect to the intensity of laser light changes depending on the measurement environment.

When the intensity of laser light emitted to the sample matrix mixture is lower than the optimal value in the MALDI ion source, a peak of the sample is not detected in a mass spectrum. On the other hand, when the intensity of laser light emitted to the sample matrix mixture is higher than the optimal value, space charge occurs in the ion separator. When space charge occurs, a mass value (m/z value) at which a peak of the sample is detected in the mass spectrum is shifted to a mass value heavier than the original value. Further, when space charge occurs, a difference between a peak and the lowest value between peaks is small in the mass spectrum, and it is difficult to detect a peak. As a result, accuracy, resolution and reproducibility of the mass analysis are deteriorated. Therefore, an operator is required to adjust the intensity of laser light according to the sample and the measurement environment.

If the intensity of laser light is close to the optimal value, the operator may finely adjust the intensity of laser light to the optimal value while checking the mass spectrum such that a peak of the sample is clear. This operation of fine adjustment is not a heavy burden on the operator. However, it takes time and labor to adjust the intensity of laser light to the optimal value when the analysis operation is started. With a peak of the sample not observed in the mass spectrum, the operator is required to adjust the intensity of laser light by increasing or decreasing the intensity of laser light while being uncertain.

An object of the present invention is to provide a mass spectrometer, a laser light intensity adjusting method and a non-transitory computer readable medium storing a laser light intensity adjusting program for enabling reduction of a burden required for an operator to adjust intensity of laser light.

(1) A mass spectrometer according to one aspect of the present invention includes a MALDI ion source, an ion separator that separates ions generated from the MALDI ion source, a detector that detects ions ejected from the ion separator, a data processor that acquires a mass spectrum of the ions detected in the detector, and a controller that controls intensity of laser light with which the MALDI ion source is irradiated. The controller includes a determiner that determines whether a peak of a matrix is detected in the mass spectrum acquired in the data processor while increasing intensity of laser light emitted to a sample matrix mixture in which a sample and the matrix are mixed from a first intensity, and a setter that acquires intensity of laser light at a time point at which the peak of the matrix is detected as a second intensity, and sets the second intensity as intensity of laser light used for analysis of the sample.

In the mass spectrometer, the determiner determines whether a peak of the matrix is detected. The setter sets the intensity of laser light at the time point at which a peak of the matrix is detected as the intensity of laser light for analysis of the sample. This mass spectrometer reduces a burden required for the operator to adjust the intensity of laser light.

(2) The matrix may include CHCA (α-cyano-4-hydroxycinnamic acid). It was found that reproducibility was high when a trimer of CHCA was used, and a correlation between the intensity of laser light at which a peak of CHCA was detected and the intensity of laser light at which a peak of the sample was detected in the mass spectrum was likely to be acquired. Therefore, the mass spectrometer can adjust the intensity of laser light for analysis of the sample by detecting a peak of CHCA.

(3) The ion separator may include an ion trap. Mass separation of the ions generated from the MALDI ion source is carried out by the ion trap.

(4) According to another aspect of the present invention, a laser light intensity adjusting method of adjusting intensity of laser light in a mass spectrometer that utilizes MALDI, includes emitting laser light to a sample matrix mixture in which a sample and a matrix are mixed, acquiring a mass spectrum of ions generated from the sample matrix mixture by emittance of the laser light, determining whether a peak of the matrix is detected based on the acquired mass spectrum while increasing intensity of the laser light emitted to the sample matrix mixture from a first intensity, and acquiring intensity of laser light at a time point at which the peak of the matrix is detected as a second intensity and using the second intensity as intensity of laser light used for analysis of the sample.

This laser light intensity adjusting method reduces a burden required for the operator to adjust the intensity of laser light.

A laser light intensity adjusting program according to yet another aspect of the present invention for adjusting intensity of laser light in a mass spectrometer utilizing MALDI, wherein a non-transitory computer readable medium storing the laser light intensity adjusting program allows a computer to execute a process of determining whether a peak of a matrix is detected based on a mass spectrum of ions generated from a sample matrix mixture while increasing intensity of the laser light emitted to the sample matrix mixture in which a sample and the matrix are mixed from a first intensity, and a process of acquiring intensity of the laser light at a time point at which the peak of the matrix is detected as a second intensity and setting the second intensity as intensity of the laser light used for analysis of the sample.

This non-transitory computer readable medium storing the laser light intensity adjusting program reduces a burden required for the operator to adjust the intensity of laser light.

The present invention can reduce a burden required for the operator to adjust the intensity of laser light in the mass spectrometer utilizing the MALDI.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is a diagram showing overall configuration of a mass spectrometer according to the present embodiment;

FIG. 2 is a block diagram showing a controller and functions around the controller;

FIG. 3 is a flow chart showing a laser light intensity adjusting method according to the present embodiment; and

FIG. 4 is a diagram showing a mass spectrum that is acquired by the change of intensity of laser light emitted to a MALDI ion source.

### DESCRIPTION OF THE PREFERRED EMBODIMENTS

### (1) Overall Configuration of Mass Spectrometer

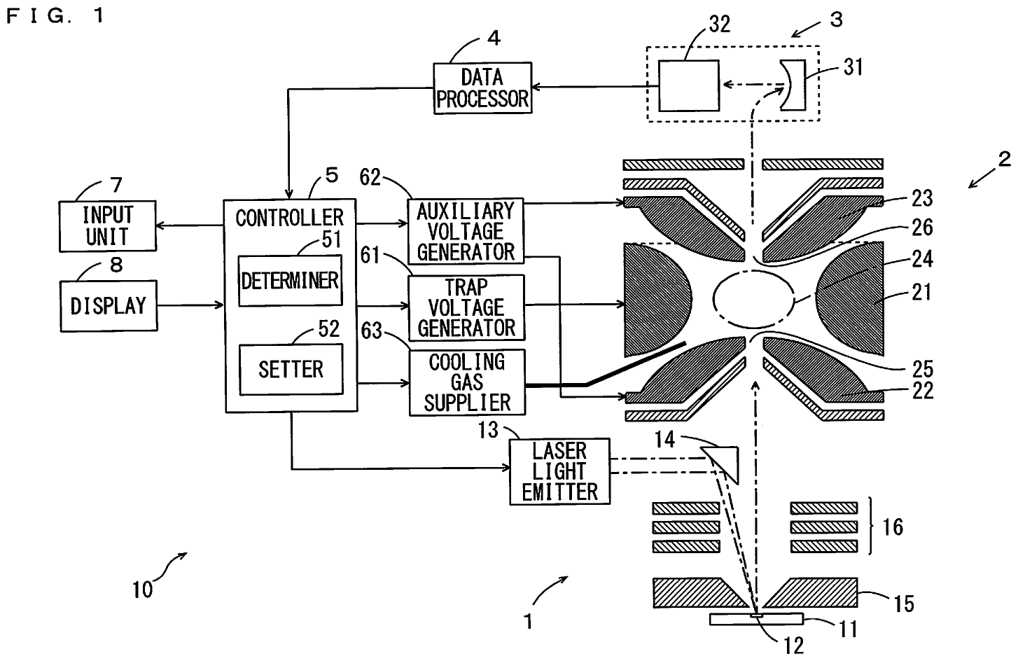

FIG. 1 is a diagram showing the overall configuration of a mass spectrometer 10 according to the present embodiment. In the present embodiment, the mass spectrometer 10 is a Matrix Assisted Laser Desorption/Ionization Digital Ion Trap Mass Spectrometer (MALDI-DIT-MS). The mass spectrometer 10 includes an MALDI ion source 1 utilizing MALDI (Matrix Assisted Laser Desorption/lonization), an ion trap 2, a detector 3, a data processor 4, a controller 5, an input unit 7 and a display 8. The ion trap 2 is an example of an ion separator in the present invention.

The MALDI ion source 1 irradiates a sample matrix mixture 12 prepared on a sample plate 11 with laser light, which is an ultraviolet ray. In the present embodiment, a trimer of CHCA (α-cyano-4-hydroxycinnamic acid) is utilized as a matrix. The MALDI ion source 1 includes a laser light emitter 13, a reflecting mirror 14, an aperture 15 and an einzel lens 16.

The laser light emitter 13 outputs laser light with which the sample matrix mixture 12 on the sample plate 11 is irradiated. A nitrogen laser or a YAG laser, for example, is used as the laser light. The reflecting mirror 14 changes the direction of the light path of the laser light that is output from the laser light emitter 13 to the direction towards the sample matrix mixture 12. The laser light, the light path of which is changed in the reflecting mirror 14, is collected at the sample matrix mixture 12 on the sample plate 11.

The aperture 15 is arranged between the sample plate 11 and the ion trap 2. The aperture 15 shields the diffusion of ions generated from the sample matrix mixture 12 to the surrounding. The einzel lens 16 is an ion transport optical system for transporting ions that have passed through the aperture 15 to the ion trap 2. As the ion transport optical system, various structures other than the einzel lens 16 such as an electrostatic lens optical system may be used.

The ion trap 2 is a three-dimensional quadrupole ion trap. The ion trap 2 includes an annular ring electrode 21 having an inner surface shaped like a hyperboloid of revolution of one sheet and a pair of end-cap electrodes 22, 23 having an inner surface shaped like a hyperboloid of revolution of two sheets. An ion trap region 24 is formed in the space surrounded by the ring electrode 21 and the end-cap electrodes 22, 23. An ion inlet port 25 is provided at the center of the end-cap electrode 22. An ion outlet port 26 is provided at the center of the end-cap electrode 23.

The ion trap 2 further includes a capturing voltage generator 61, an auxiliary voltage generator 62 and a cooling gas supplier 63. The capturing voltage generator 61 adds a square-wave voltage having a predetermined frequency to the ring electrode 21. The auxiliary voltage generator 62 respectively adds predetermined voltages (a direct-current voltage or a high frequency voltage) to the pair of end-cap electrodes 22, 23. The cooling gas supplier 63 supplies a cooling gas into the ion trap 2. An inert gas is generally used as a cooling gas, and the ions in the ion trap 2 are cooled.

The detector 3 includes a conversion dynode 31 and a secondary electron multiplier 32. The conversion dynode 31 is provided outside of the ion outlet port 26, and converts ions discharged from the ion trap 2 into electrons. The secondary electron multiplier 32 multiplies each electron that have been converted in the conversion dynode 31 and detects the multiplied electron. The detector 3 can detect both positive ions and negative ions. The electron detected in the detector 3 is supplied to the data processor 4 as a detection signal. The data processor 4 converts the detection signal received from the detector 3 into a digital detection signal, and performs an analysis process based on the digital detection signal. The data processor 4 produces a mass spectrum of ions based on the detection signal as one of the analysis processes.

The controller 5 includes a determiner 51 and a setter 52. The functions of the determiner 51 and the setter 52 will be described below. The input unit 7 receives operator's various operations with respect to the controller 5. The display 8 displays various setting information in the mass spectrometer 10, results of data processing by the data processor 4 and the like.

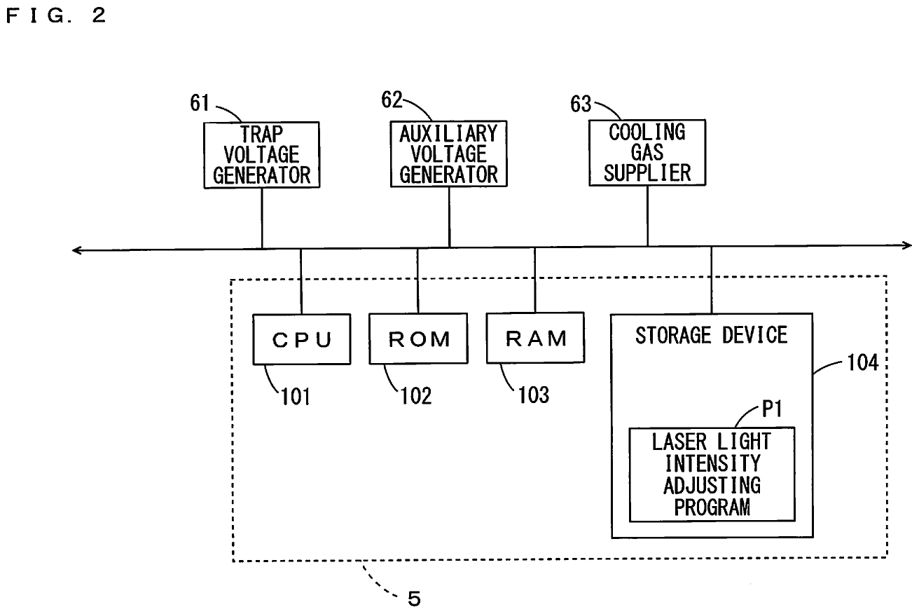

FIG. 2 is a block diagram showing the configuration of the controller 5 and the configuration of the functions around the controller 5. The controller 5 includes a CPU 101, a ROM 102, a RAM 103 and a storage device 104. The CPU 101 controls the mass spectrometer 10 based on a control program stored in the ROM 102. The CPU 101 controls the capturing voltage generator 61 and the auxiliary voltage generator 62 by executing the control program, and allows ions supplied from the MALDI ion source 1 to be captured in the ion trap 2. The CPU 101 controls the cooling gas supplier 63 by executing the control program and allows a cooling gas to be supplied to the ion trap 2 and cools the ions in the ion trap 2. The CPU 101 further controls the laser light emitter 13 by executing the control program and allows the laser light to be emitted to the sample matrix mixture 12.

### (2) Operations of Mass Spectrometer

The mass spectrometer 10 having the above-mentioned configuration acquires a mass spectrum by the following operations. First, the laser light emitter 13 is controlled by the controller 5 to emit the laser light to the sample matrix mixture 12. Ions generated from the sample matrix mixture 12 pass through the aperture 15 and the einzel lens 16 and are introduced into the ion trap 2 through the ion inlet port 25.

The capturing voltage generator 61 is controlled by the controller 5 to add a square-wave voltage having a predetermined frequency to the ring electrode 21, whereby the introduced ions are captured in the ion trap region 24. Prior to introduction of the ions into the ion trap 2, the cooling gas supplier 63 is controlled by the controller 5 to supply a cooling gas to the ion trap 2. The ions introduced into the ion trap 2 collide with the cooling gas, and kinetic energy is reduced. Thus, the ions are likely to be captured in the ion trap region 24.

The auxiliary voltage generator 62 is controlled by the controller 5 to add a high frequency voltage to the end-cap electrodes 22, 23 with the square-wave voltage added to the ring electrode 21. Thus, ions having a specific mass are resonantly excited (excitation). The excited ions having the specific mass are discharged from the ion outlet port 26 and detected in the detector 3. The ion detection signal detected in the detector 3 is supplied to the data processor 4.

The frequency of the square-wave voltage added to the ring electrode 21 by the capturing voltage generator 61 and the frequency of the high frequency voltage added to the end-cap electrodes 22, 23 by the auxiliary voltage generator 62 are scanned by the control of the controller 5, whereby the ions discharged from the ion outlet port 26 are scanned in regards to differences in their masses. Thus, ions on which mass-scan is performed and which are discharged sequentially are detected in the detector 3. Thus, the data processor 4 acquires a mass spectrum based on the detection signal supplied from the detector 3.

### (3) Laser Light Intensity Adjusting Method

The laser light intensity adjusting method according to the present embodiment will be described next. As shown in FIG. 2, a laser light intensity adjusting program P1 is stored in the storage device 104. The determiner 51 and the setter 52 shown in FIG. 1 are functions that are realized by the CPU 101 that executes the laser light intensity adjusting program P1 while using the RAM 103 as a work area.

The determiner 51 determines whether a peak of a matrix is detected in the mass spectrum acquired in the data processor 4. As described above, the mass spectrum is acquired in the data processor 4 based on the ions generated from the sample matrix mixture 12. This mass spectrum includes the mass spectrum of the sample and the mass spectrum of the matrix.

As described above, the timer of CHCA is used as the matrix in the present embodiment. Further, it was found that the correlation between the intensity of laser light at which a peak of the trimer of CHCA was detected and the intensity of laser light at which a peak of the sample was detected in the mass spectrum was acquired. That is, it was found that, although the optimal intensity of laser light at which a peak was detected was different for different samples and different measurement environments, there was generally a correlation between the sample and the trimer of CHCA in regards to the optimal intensity of laser light at which a peak was detected. As such, the determiner 51 determines whether a peak of the trimer of CHCA is detected.

First, the determiner 51 sets the intensity of laser light emitted from the laser light emitter 13 as a first intensity. As the first intensity, a sufficiently small value, which has been empirically proven to be the value at which a peak of the trimer of CHCA is not detected, is selected. The determiner 51 further acquires the data of the mass spectrum from the data processor 4 and determines whether a peak of the trimer of CHCA is detected in the mass spectrum. Specifically, the determiner 51 determines whether a peak is detected at 568 (m/z), which is the mass of the trimer of CHCA. A known method is used as the method of detecting a peak in the mass spectrum. In the present embodiment, the sample used for analysis is presumably a large substance having a relatively large mass. That is, it is presumed that the mass of the sample is relatively large, and a peak does not appear at a mass around 568 (m/z), which is the mass of the trimer of CHCA. The sample used for analysis is a polymer such as a biopolymer or a synthetic polymer.

When a peak of the trimer of CHCA is not detected in the mass spectrum, the determiner 51 adds a predetermined value to the intensity of laser light emitted by the laser light emitter 13. The determiner 51 acquires a mass spectrum from the data processor 4 and determines whether a peak of the matrix is detected every time the predetermined value is added to the intensity of laser light emitted by the laser light emitter 13.

The determiner 51 repeatedly detects a peak of the matrix while increasing the intensity of laser light. Further, the determiner 51 stops the addition to the intensity of laser light emitted by the laser light emitter 13 at the time point at which detection of a peak of the matrix is determined. As described above, the known method is used for detection of a peak. The determiner 51 repeats the process of adding the predetermined value with the first intensity as an initial value of the intensity of laser light, and stops the addition to the intensity of laser light at the time point at which a peak of the matrix is detected for the first time in the mass spectrum.

The setter 52 acquires the intensity of laser light at the time point at which the determiner 51 detects a peak of the matrix as a second intensity. Then, the setter 52 sets the second intensity as the intensity of laser light used for analysis of the sample. Thus, the controller 5 sets the second intensity as the initial value of the intensity of laser light, and starts the analysis process of the sample. The laser light emitter 13 emits the laser light of the second intensity to the sample matrix mixture 12. Ions generated from the sample matrix mixture 12 pass through the ion trap 2 to be detected in the detector 3. The detection signal detected in the detector 3 is analyzed and processed by the data processor 4, and a mass spectrum is acquired. The controller 5 acquires the mass spectrum from the data processor 4 and displays the mass spectrum in the display 8.

Because the intensity of laser light is set to the second intensity, a peak of the trimer of CHCA is acquired. As described above, it was found that a correlation between the intensity of laser light at which a peak of the trimer of CHCA was detected and the intensity of laser light at which a peak of the sample was detected in the mass spectrum was likely to be acquired. Therefore, a difference between the intensity of laser light at which a peak is acquired in the sample and the second intensity is not large. The operator may observe the mass spectrum displayed in the display 8, operate the input unit 7 and adjust the intensity of laser light such that a peak of the sample is acquired. The initial value of the intensity of laser light is set to the second intensity based on the detection of a peak of the matrix. Thus, a burden on the operator who adjusts the intensity of laser light such that a peak of the sample is detected is reduced.

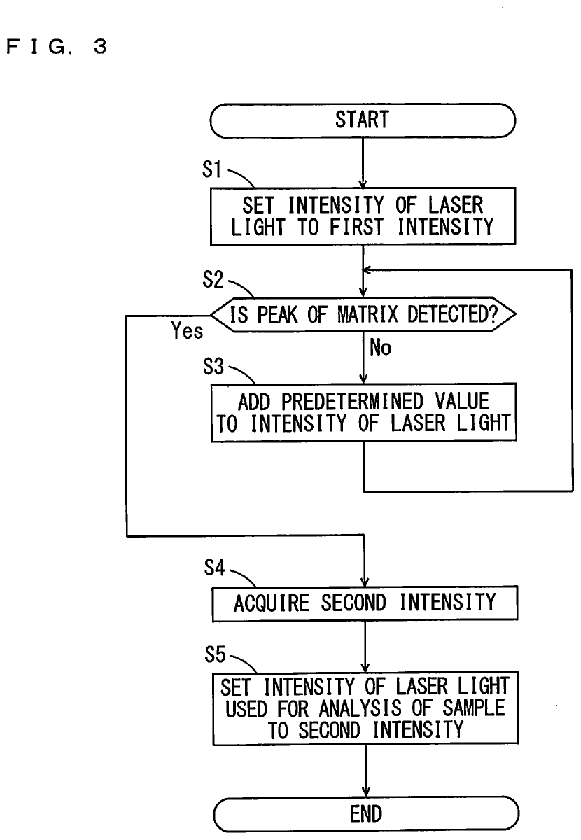

FIG. 3 is a diagram showing a flow of the process of the laser light intensity adjusting program P1 executed by the CPU 101. First, the determiner 51 sets the intensity of laser light to the first intensity (step S1). Thus, the laser light emitter 13 emits the laser light of the first intensity to the sample matrix mixture 12. Thus, the ions generated from the MALDI ion source 1 are introduced into the ion trap 2, and the ions discharged from the ion trap 2 are detected in the detector 3. Further, the mass spectrum is acquired by the data processor 4 based on the ions detected in the detector 3.

Next, the determiner 51 acquires the mass spectrum from the data processor 4, and determines whether a peak of the matrix is detected (step S2). When a peak of the matrix is not detected, the determiner 51 adds the predetermined value to the intensity of laser light (step S3). Thus, the laser light emitter 13 emits the laser light to the sample matrix mixture 12 at the intensity acquired by addition of the predetermined value to the first intensity. Thus, ions are detected based on the changed intensity of laser light, and a mass spectrum is newly acquired in the data processor 4. Then, the determiner 51 returns to the step S2 and determines again whether a peak of the matrix is detected.

When the determiner 51 detects a peak of the matrix in the step S2, the setter 52 acquires the second intensity of laser light (step S4). As described above, the setter 52 acquires the intensity of laser light at the time point at which a peak of the matrix is detected as the second intensity. Then, the setter 52 sets the second intensity as the intensity of laser light used for analysis of the sample (step S5).

In the mass spectrometer 10 of the present embodiment, the determiner 51 determines whether a peak of the matrix is detected. The setter 52 sets the second intensity, which is the intensity of laser light at the time point at which a peak of the matrix is detected, as the intensity of laser light for analysis of the sample. The present embodiment reduces a burden required for the operator to adjust the intensity of laser light.

Further, the mass spectrometer 10 uses the trimer of CHCA as the matrix. It was found that reproducibility was high when a trimer of CHCA was used, and a correlation between the intensity of laser light at which a peak of CHCA was detected and the intensity of laser light at which a peak of the sample was detected in the mass spectrum was likely to be acquired. Therefore, the mass spectrometer 10 can adjust the intensity of laser light for analysis of the sample by detecting a peak of the CHCA.

### (4) Correlation Between Sample and Matrix in Peak Detection

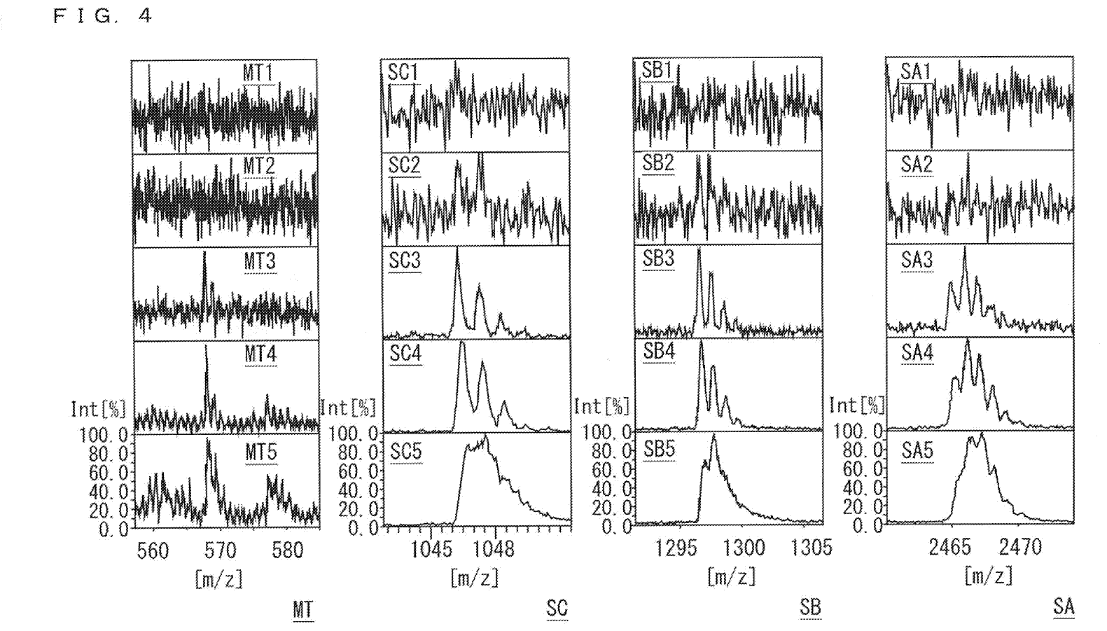

As described above, it was found that a correlation between the intensity of laser light at which a peak of the trimer of CHCA was detected and the intensity of laser light at which a peak of the sample was detected in the mass spectrum was likely to be acquired. FIG. 4 shows diagrams of the mass spectrums that are acquired by the change of the intensity of laser light emitted to the MALDI ion source 1. FIG. 4 shows the examples of mass spectrums using sample matrix mixtures 12 in which a matrix MT and one of three types of samples SA, SB, SC are mixed. A trimer of CHCA was used as a matrix MT. As the sample SA, adrenocorticotropic hormone (ACTH18-39: the molecular weight was 2465.70) was used. As the sample SB, angiotensin I (Angiotensin 1: the molecular weight was 1296.48) was used. As the sample SC, angiotensin II (Angiotensin 2: the molecular weight was 1046.18) was used.

The SA1 to SA5 in FIG. 4 are mass spectrums in the range of molecular weights close to the molecular weight of the sample SA, the SB1 to SB5 are mass spectrums in the range of molecular weights close to the molecular weight of the sample SB, and the SC1 to SC5 are mass spectrums in the range of molecular weights close to the molecular weight of the sample SC. Further, the MT1 to MT5 in FIG. 4 are mass spectrums in the range of molecular weights close to the molecular weight of the matrix MT. The mass spectrums SA1, SB1, SC1, MT1 are mass spectrums of the ions acquired at the laser intensity L1. The mass spectrums SA2, SB2, SC2, MT2 are mass spectrums of the ions acquired at the laser intensity L2, the mass spectrums SA3, SB3, SC3, MT3 are mass spectrums of the ions acquired at the laser intensity L3, the mass spectrums SA4, SB4, SC4, MT4 are mass spectrums of the ions acquired at the laser intensity L4, and the mass spectrum SA5, SB5, SC5, MT5 are mass spectrums of the ions acquired at the laser intensity L5, respectively. The magnitude of the laser intensity can be expressed by L1<L2<L3<L4<L5.

As shown in the diagram, at the laser intensity L1, a peak is not observed in any of the mass spectrums SA1, SB1, SC1, MT1. That is, a peak is not observed in any of the matrix MT and the samples SA, SB, SC. At the laser intensity L2, a peak is not observed in the mass spectrum MT2. Although a peak is slightly observed in each of the mass spectrums SA2, SB2, SC2, a peak required for specifying the mass is not observed. At the laser intensity L3, a peak is observed in the mass spectrum MT3. Further, a required peak that is sufficient for specification of a mass is also observed in each of the mass spectrums SA3, SB3, SC3. It was found that, at the laser intensity L4, a peak of the sample was shifted and resolution was deteriorated due to space charge in each of the mass spectrums SA4, SB4, SC4. At the laser intensity L5, a peak is further shifted and resolution is further deteriorated in each of the mass spectrums SA5, SB5, SC5, and a mass cannot be specified.

From the results of measurement in FIG. 4, it is found that there is a correlation between the sample and the matrix in regards to the intensity of laser light at which a peak is detected. In the example of FIG. 4, at the laser intensity L3, a peak was detected in the mass spectrum MT3, and a peak was also detected in each of the mass spectrums SA3, SB3, SC3. Therefore, setting the laser intensity L3 as the second intensity at the time point at which a peak is detected in the mass spectrum MT3 relating to the matrix MT is found to be effective. For example, the laser intensity L1 at which a peak is not detected even in the matrix MT may be set as the first intensity.

### (5) Other Embodiments

While the ion trap 2 is described as the ion separator in the above-mentioned embodiment by way of example, TOF (Time of Flight Mass Spectrometry) may be utilized as the ion separator. While a trimer of CHCA is used as a matrix in the above-mentioned embodiment, another matrix may be used if a correlation between the intensity of laser light at which a peak of another matrix is detected and the intensity of laser light at which a peak of the sample is detected is acquired. For example, a dimer of CHCA or the like is used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

I/We claim:

1. A mass spectrometer comprising:
a MALDI ion source utilizing MALDI (Matric Assisted Laser Desorption/Ionization);
an ion separator that separates ions generated from the MALDI ion source;
a detector that detects ions ejected from the ion separator;
a data processor that acquires a mass spectrum of the ions detected in the detector; and
a controller that controls intensity of laser light with which the MALDI ion source is irradiated, wherein
the controller includes
a determiner that determines whether a peak of a matrix is detected in the mass spectrum acquired in the data processor while increasing intensity of laser light emitted to a sample matrix mixture in which a sample and the matrix are mixed from a first intensity, and
a setter that acquires intensity of laser light at a time point at which the peak of the matrix is detected as a second intensity, and sets the second intensity as intensity of laser light used for analysis of the sample.

2. The mass spectrometer according to claim 1, wherein
the matrix includes CHCA (α-cyano-4-hydroxycinnamic acid).

3. The mass spectrometer according to claim 1, wherein
the ion separator includes an ion trap.

4. A laser light intensity adjusting method of adjusting intensity of laser light in a mass spectrometer that utilizes MALDI (Matrix Assisted Laser Desorption/Ionization), including:
emitting laser light to a sample matrix mixture in which a sample and a matrix are mixed;
acquiring a mass spectrum of ions generated from the sample matrix mixture by emittance of the laser light;
determining whether a peak of the matrix is detected based on the acquired mass spectrum while increasing intensity of the laser light emitted to the sample matrix mixture from a first intensity; and
acquiring intensity of laser light at a time point at which the peak of the matrix is detected as a second intensity and using the second intensity as intensity of laser light used for analysis of the sample.

5. A non-transitory computer readable medium storing a laser light intensity adjusting program for adjusting intensity of laser light in a mass spectrometer utilizing MALDI (Matrix Assisted Laser Desorption/Ionization),
the laser light intensity adjusting program allowing a computer to execute:
a process of determining whether a peak of a matrix is detected based on a mass spectrum of ions generated from a sample matrix mixture while increasing intensity of the laser light emitted to the sample matrix mixture in which a sample and the matrix are mixed from a first intensity; and
a process of acquiring intensity of the laser light at a time point at which the peak of the matrix is detected as a second intensity and setting the second intensity as intensity of the laser light used for analysis of the sample.
